(19) United States
(12) Patent Application Publication
(10) Pub. No.: US 2012/0127848 A1
(43) Pub. Date: May 24, 2012

(54) RECORDING MEDIUM, METHOD OF INITIALIZING THE SAME, INITIALIZING DEVICE, AND REPRODUCING METHOD

(75) Inventors: Kimihiro Saito, Kanagawa (JP); Seiji Kobayashi, Kanagawa (JP); Yojiro Sumi, Kanagawa (JP)

(73) Assignee: SONY CORPORATION, Tokyo (JP)

(21) Appl. No.: 13/293,386

(22) Filed: Nov. 10, 2011

(30) Foreign Application Priority Data
Nov. 24, 2010 (JP) 2010-260987

(51) Int. Cl. G11B 7/26

(52) U.S. Cl. 369/284; G9B/7.194

(57) ABSTRACT

There is provided a method of initializing a recording medium having a first surface and a second surface which face to each other with a recording layer in between. The method includes forming interference patterns to have a pitch wider than λr/2N by applying initializing light of a plane wave with a wavelength λf to the recording layer from both of the first surface side and the second surface side, where λr is a wavelength of reproducing light applied to the recording layer at the time of reproducing recorded information, and N is an average refractive index of the recording layer.

### BACKGROUND

This disclosure relates to a recording medium including a recording layer to which information is recorded by erasing or changing, on a portion irradiated by collected light, interference patterns formed parallel to a surface of the recording medium, and from which recorded information is reproduced by reflected light with respect to irradiation of the collected light, and to a method of initializing the same, an initializing device, and a reproducing method.

In optical disc systems such as Compact Disc (CD), Digital Versatile Disc (DVD), and Blu-ray Disc® (BD), a slight change of reflectance formed on one surface of a disc is read in a non-contact manner like an objective lens of a microscope. As is well known, a size of a light spot on the disc is given substantially by λ/NA (λ: a wavelength of illumination light, NA: the number of openings), and the resolution also correlates with this value. For example, in BD, capacity of approximately 25 GB is achieved in a disc having a diameter of 12 cm. In addition, it is known that a plurality of recording layers is overlaid to increase capacity of one disc.

On the other hand, a method of recording a standing wave has been proposed. Light is once collected in a recording medium such as an optical disc whose refractive index is varied by intensity of irradiated light, and then light is collected again on the same focal position from opposite direction with use of a reflection device provided on a back surface of the recording medium. Accordingly, hologram having small light spots is formed to record information therein. At the time of reproduction, similarly, reflected light of irradiated light from a front surface of the disc is read to identify information. In addition, by recording information in a form of layers in an optical recording medium, multilayer recording is allowed to be performed. In the method, however, optical systems need to be arranged on both of front and back surfaces of a recording medium such as an optical disc, and thus an entire optical system or a drive system is disadvantageously increased in size and complicated.

Moreover, in “Three-dimensional optical disk data storage via the localized alteration of a format hologram”, R. R. Mcleod, A. J. Daiber, T. Honda, M. E. McDonald, T. L. Robertson, T. Slagle, S. L. Sochava, and L. Hesselink, Appl. Opt., Vol. 47, (2008) pp 2696-2707, a method of recording interference patterns on an entire surface in an optical disc once (pre-format) and performing mark recording by erasing/changing a part of the interference patterns is proposed.

### SUMMARY

A method of performing mark recording by erasing or changing interference patterns, which is described in “Three-dimensional optical disk data storage via the localized alteration of a format hologram”, R. R. Mcleod, A. J. Daiber, T. Honda, M. E. McDonald, T. L. Robertson, T. Slagle, S. L. Sochava, and L. Hesselink, Appl. Opt., Vol. 47, (2008) pp 2696-2707, advantageously eliminates needs for arranging light paths of both surfaces of the disc in a pickup for recording/reproduction. In the method, however, a favorable reproducing signal may not be obtained due to a relationship between the interference patterns and the reproducing light in some cases. Therefore, there is a need for providing a favorable reproducing signal with sufficient modulation degree in a method of performing mark recording by erasing or changing interference patterns formed in a recording medium.

According to an embodiment of the technology, there is provided a method of initializing a recording medium having a first surface and a second surface which face to each other with a recording layer in between. The method includes forming interference patterns to have a pitch wider than λr/2N by applying initializing light of a plane wave with a wavelength λf to the recording layer from both of the first surface side and the second surface side. Note that λr is a wavelength of reproducing light applied to the recording layer at the time of reproducing recorded information, and N is an average refractive index of the recording layer. In the recording medium, the interference patterns formed parallel to a surface of the recording medium is erased or changed in a portion irradiated with collected light, and thus information is recorded. In addition, recorded information is reproduced by reflected light with respect to irradiation of the collected light. In this case, a pitch of the interference patterns formed is wider than λr/2N by setting the wavelength λf of the initializing light to be larger than λr. Specifically, it is preferable that a value of λf/λr be in a range of 1.005 to 1.09. Alternatively, a pitch of the interference patterns formed is wider than λr/2N by setting the wavelength λf of the initializing light to be equal to or larger than λr, and setting an incident angle of the initializing light applied to the first surface on the recording layer to be different from an incident angle of the initializing light applied to the second surface on the recording layer.

According to an embodiment of the technology, there is provided an initializing device including a first irradiation optical system applying initializing light of a plane wave with a wavelength λf to a recording layer of a recording medium, which has a first surface and a second surface which face to each other with the recording layer in between, from the first surface side, and a second irradiation optical system applying initializing light of a plane wave with a wavelength λf to the recording layer from the second surface side. Herein, when the wavelength of reproducing light applied to the recording layer at the time of reproducing recorded information is λr, the wavelength λf of the initializing light is larger than λr, and a value of λf/λr is within a range of 1.005 to 1.09. The initializing device is to form interference patterns in the recording medium.

In addition, the initializing device according to an embodiment of the technology includes a first irradiation optical system irradiating a first surface of the recording layer of the recording medium with initializing light of a plane wave with a wavelength λf at a first incident angle, and a second irradiation optical system irradiating a second surface of the recording layer of the recording medium with the initializing light of a plane wave with the wavelength λf at a second incident angle different from the first incident angle. Incidentally, in this case, when the wavelength of reproducing light applied to the recording layer at the time of reproduction is λr, the wavelength λf of the initializing light is equal to or larger than λr.

According to an embodiment of the technology, there is provided a recording medium including a recording layer. In the recording medium, a pitch of interference patterns in the recording layer is wider than λr/2N. Note that λr is a wavelength of reproducing light applied to the recording layer at the time of reproducing recorded information and N is an average refractive index of the recording layer. Specifically, the pitch of the interference patterns is within a range of (λr*1.005)/2N to (λr*1.09)/2N.

According to an embodiment of the technology, there is provided a method of reproducing information including applying reproducing light having a wavelength λr smaller than λf to a recording layer of a recording medium and reproducing information from reflected light of the reproducing light, the recording layer including interference patterns formed at a pitch of λf/2N. Incidentally, λf is a wavelength of initializing light of a plane wave in a case where interference patterns having a pitch of λf/2N is formed by applying the initializing light to the recording layer from both of facing two surface sides of the recording medium at the time of forming the interference patterns on the recording layer for initializing the recording medium, and N is an average refractive index of the recording layer. This method is a method of reproducing information recorded in the recording medium. Specifically, in this method, reproducing light having a wavelength λr which allows a value of λf/λr to be within a range of 1.005 to 1.09 is applied to the recording layer, and information is reproduced from reflected light of the reproducing light.

In the recording medium, the method of initializing the same, the initializing device, and the reproducing method according to the embodiment of the technology, the pitch of the interference patterns formed in the recording layer of the recording medium is wider than λr/2N. When the interference patterns are formed by irradiating front and back surfaces of the recording medium with initializing light of a plane wave with wavelength λf, the pitch of the interference patterns is λf/2N. At the time of recording, the interference patterns are erased or changed by collected light to form marks. Mark portions are formed as regions with respective refractive indices. In this case, if reproduction is performed on the assumption that the wavelength λr of reproducing light is equal to λf, an optimum reproducing signal is not obtainable. However, in a case where the pitch λr/2N of the interference patterns is set to be wider than λr/2N, a reproducing signal with sufficient modulation degree is obtainable when reproduction is performed using reproducing light with the wavelength λr. To obtain the pitch of the interference patterns, the wavelength λf of the initializing light may be set to be larger than λr. Alternatively, even if λf is equal to λr, the incident angles of the initializing light applied to the front surface and the back surface at the time of initialization may be different from each other. As viewed from a reproducing device side, when the pitch of the interference patterns is represented by λf/2N, reproducing light with the wavelength λr smaller than λf may be used.

According to the technology, a reproducing signal with optimum modulation degree is obtainable at the time of reproduction in a method of performing mark recording by erasing or changing interference patterns.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is an explanatory diagram of an initializing device according to an embodiment of the disclosure.

FIGS. 2A and 2B are explanatory diagrams of initialization by a plane wave of the embodiment.

FIGS. 3A and 3B are explanatory diagrams of a refractive-index distribution after mark recording of the embodiment.

FIG. 4 is a block diagram of a recording/reproducing device of the embodiment.

FIG. 5 is an explanatory diagram of an optical system of the recording/reproducing device of the embodiment.

FIG. 6 is an explanatory diagram of a reproducing signal measurement of the embodiment.

FIGS. 7A to 7C are explanatory diagrams of results of the reproducing signal measurement of the embodiment.

FIG. 8 is an explanatory diagram of measurement results of a signal modulation degree of the embodiment.

FIGS. 9A and 9B are explanatory diagrams of measurement waveforms at a sample point SP1 of the embodiment.

FIGS. 10A and 10B are explanatory diagrams of measurement waveforms at a sample point SP2 of the embodiment.

FIGS. 11A and 11B are explanatory diagrams of measurement waveforms at a sample point SP3 of the embodiment.

FIGS. 12A and 12B are explanatory diagrams of measurement waveforms at a sample point SP11 of the embodiment.

FIGS. 13A and 13B are explanatory diagrams of measurement waveforms at a sample point SP12 of the embodiment.

FIGS. 14A and 14B are explanatory diagrams of measurement waveforms at a sample point SP13 of the embodiment.

FIG. 15 is an explanatory diagram of a refractive-index distribution of hologram recording.

FIG. 16 is an explanatory diagram of an initializing device according to another embodiment of the disclosure.

### DETAILED DESCRIPTION

Hereinafter, preferred embodiments of the disclosure will be described in the following order.

1. Initialization and recording
2. Recording/reproducing device
3. Relationship between initializing wavelength, pitch of interference patterns, and reproducing wavelength
4. Example of another initializing device

### (1. Initialization and Recording)

In the embodiment of the disclosure, as an initialization processing (pre-format), interference patterns are formed in a recording medium as a hologram disc. At the time of recording information, one surface of an initialized hologram disc is irradiated with collected light to erase or change the interference patterns, and thus mark recording is performed.

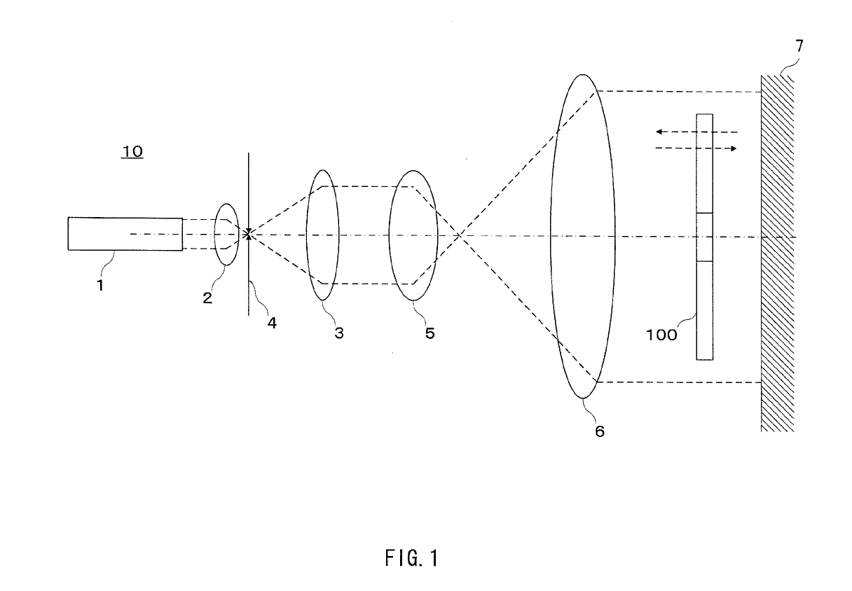

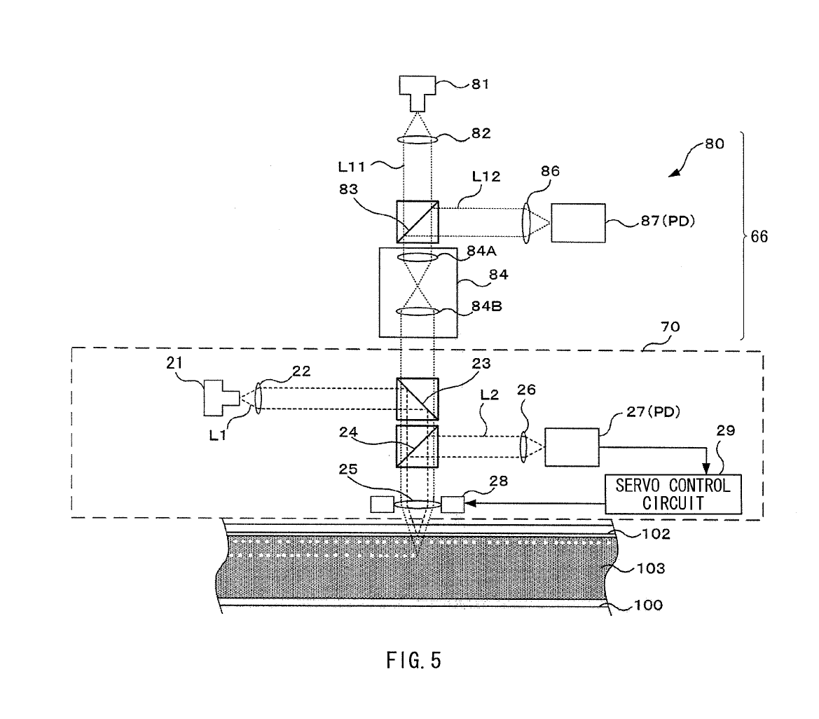

A configuration example of an initializing device 10 of the embodiment for performing the initialization processing will be described with reference to FIG. 1. In FIG. 1, a hologram disc 100 is a disc type recording medium with a predetermined thickness, for example. A predetermined region in a thickness direction of the hologram disc 100 is a volume type recording layer. For example, the hologram disc 100 has a configuration illustrated in FIG. 5 which will be described later, and includes a recording layer 103.

A laser light source 1 outputs initializing light with a wavelength λf. In the embodiment, as the wavelength λf of the initializing light, an appropriate wavelength is set from a relationship with reproducing light, which will be described later. The beam diameter of the initializing light is expanded by an expander configured with lenses 2 and 3. On a focal surface position of the lenses 2 and 3 which configure the expander, a spatial filter 4 is disposed. Further, the beam diameter of the initializing light is expanded by lenses 5 and 6. Then, one surface of the hologram disc 100 is uniformly irradiated with parallelized light of a plane wave obtained by the lens 6. Moreover, the initializing light of a plane wave is transmitted through the hologram disc 100, and then is reflected by a mirror 7. Therefore, configuration in which another surface (opposite surface) of the hologram disc 100 is irradiated with a plane wave at a time is achieved. Accordingly, the initializing device 10 includes a first irradiation optical system (from the laser light source 1 to the lens 6) perpendicularly irradiating one surface of a recording layer of the hologram disc 100 with the initializing light of a plane wave with the wavelength λf, and a second irradiation optical system (the laser light source 1 to the mirror 7) irradiating another surface of the recording surface of the hologram disc 100 with the initializing light of a plane wave with the wavelength λf. Note that the configuration of the initializing device 100 is merely an example, and other configurations are also available. For example, the second irradiation optical system may be formed with a light path independent of the first irradiation optical system.

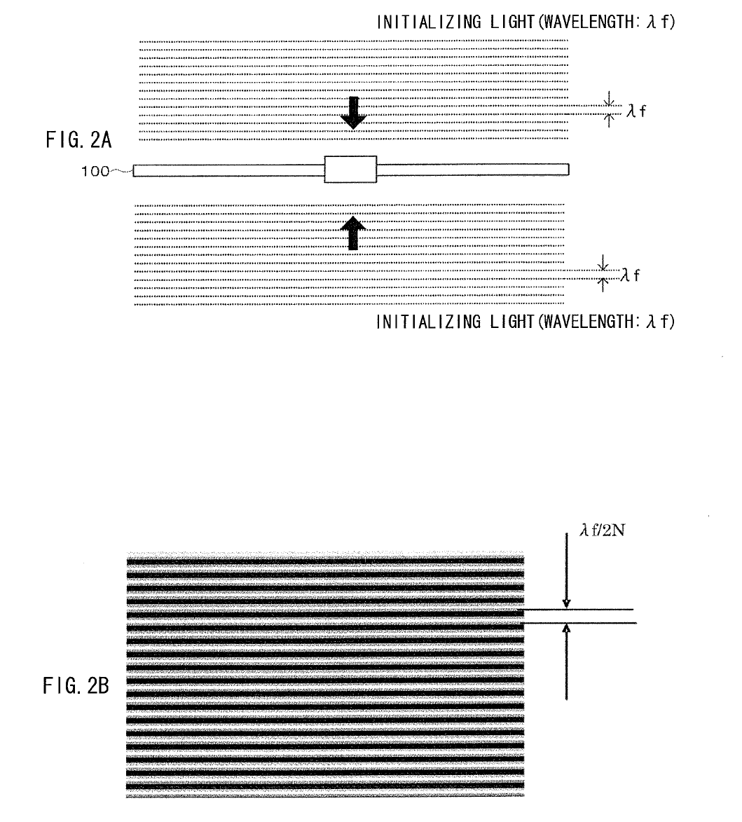

Pre-format operation in such an initializing device 10 is illustrated in FIGS. 2A and 2B. FIG. 2A schematically illustrates a state where one surface and another surface of the hologram disc 100 are uniformly irradiated with the initializing light of a plane wave with wavelength λf by, for example, the initializing device 10 as described above. In this way, a plane wave with wavelength λf enters front and back surfaces of the hologram disc 100 so that planar interference patterns with a pitch of λf/2N as illustrated in FIG. 2B are uniformly formed as a recording layer of the hologram disc 100. Note that N indicates a refractive index of a material of the recording medium. In other words, inside the hologram disc 100, gratings in which a refractive-index distribution is varied in a thickness direction are formed as a recording layer. Herein, a refractive index as a base is represented by N, and variation of the refractive index is represented by ΔN.

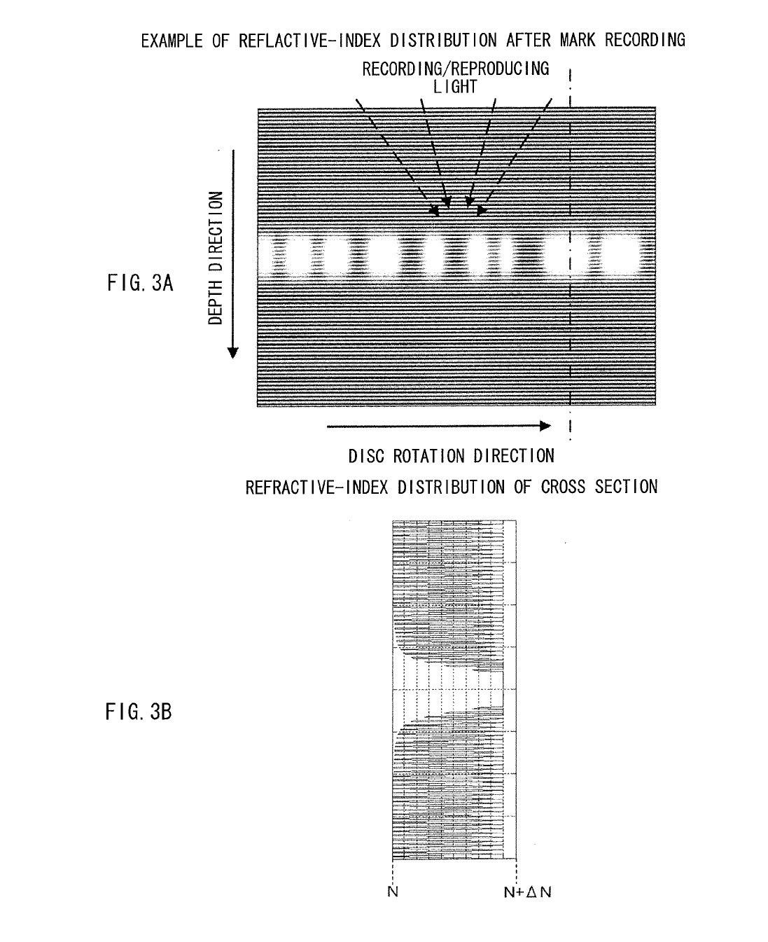

At the time of recording, marks are formed by irradiating one surface of the hologram disc 100 provided with interference patterns in this way with collected light. For example, a pickup for an optical disc such as BD may be used. FIG. 3A illustrates a recording layer having interference patterns uniformly formed in a depth direction (a thickness direction) of the hologram disc 100. By collecting and emitting recording light to be focused on a certain depth position, interference patterns on that portion are erased or changed to form marks as illustrated in the figure. FIG. 3B illustrates a refractive-index distribution on a cross section indicated by an alternate long and short dash line. In other words, in a state of uniform gratings in the initial state, the refractive index in the depth direction is varied in a range from N to N+ΔN, and the portion formed with marks has a refractive index N+ΔN continuously. The portions showing respective refractive-index variation become reproducible marks. At the time of reproduction, the reproducing light is focused on the depth position formed with the mark train and is emitted. Therefore, when reflected light of the reproducing light is detected, a reproducing signal corresponding to the mark train may be obtained from difference of the refractive index between mark portions (interference patterns disappearing portions) and portions with remained interference patterns.

Note that FIG. 3A illustrates an example where marks are formed in line on a certain depth position, however, by changing the focal position of the recording light in the depth direction, mark trains may be formed on the other depth positions. In other words, inside the recording layer provided with the interference patterns, mark trains are allowed to be formed in a multi-layer manner by focal position control of the recording light. It is obvious that, also at the time of reproduction, information in the target layer may be reproduced by controlling the focal position of the reproducing light onto the mark train as a reproduction target.

### (2. Recording/Reproducing Device)

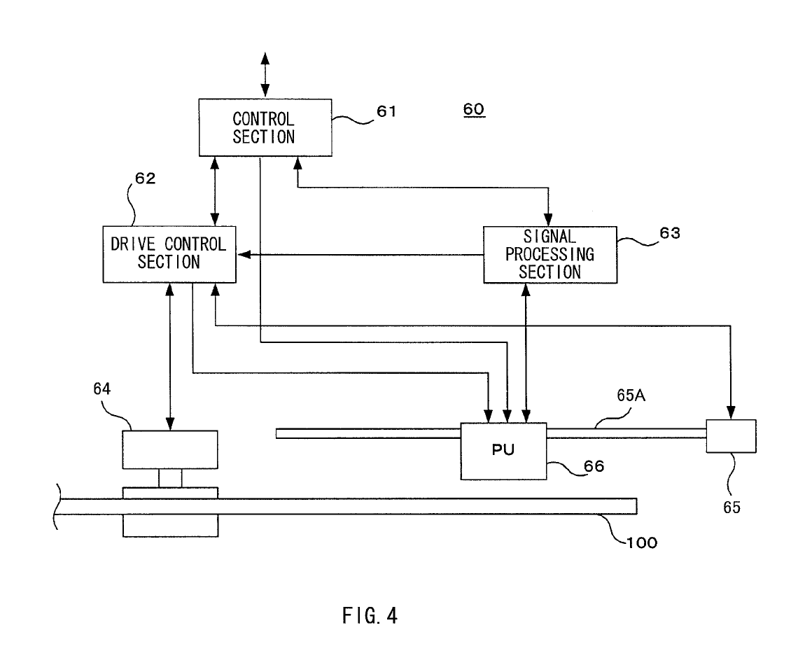

A configuration of a recording/reproducing device according to the embodiment performing recording and reproduction with respect to the initialized hologram disc 100 will be described with reference to FIGS. 4 and 5. FIG. 4 illustrates a general configuration of a recording/reproducing device 60 according to the embodiment. It is assumed that the recording/reproducing device 60 is used for recording into the initialized hologram disc 100 and reproducing information from the hologram disc 100 by a general user in a home or the like.

As illustrated in FIG. 4, the recording/reproducing device 60 includes a control section 61, a drive control section 62, a signal processing section 63, a spindle motor 64, a sled motor 65, and a optical pickup 66.

The control section 61 integrally controls the entire recording/reproducing device 60. The control section 61 is configured mainly of CPU (not illustrated). The control section 61 reads various kinds of programs such as a base program and an information recording program from a ROM (not illustrated), and then develops the read program into a RAM (not illustrated) to execute various kinds of processing such as information recording processing.

The drive control section 62 performs processing on a supplied signal and generation of a supply signal to be supplied to an actuator which will be described later. In addition, the drive control signal 62 performs various kinds of drive control processing. The signal processing section 63 performs various kinds of signal processing such as coding and decoding, or modulating and demodulating.

The spindle motor 64 drives the hologram disc 100 to rotate, based on the control of the drive control section 62. The optical pickup 66 performs laser output based on a recording signal supplied from the drive control section 62 to perform recording to the hologram disc 100. In addition, at the time of reproduction, the optical pickup 66 detects reflected-light information of the laser light reflected by the hologram disc 100. The sled motor 65 allows the optical pickup 66 to slide on a moving axis 65A. In other words, the optical pickup 66 is movable in a radial direction of the hologram disc 100.

Moreover, the optical pickup 66 performs a position control such as a focus control and a tracking control based on the control of the drive control section 62, thereby collecting laser light on a desired position. Incidentally, a focus direction indicates a direction close to or away from the hologram disc 100, and a tracking direction indicates a radial direction (namely, a direction toward inside or outside) of the hologram disc 100.

At the time of recording, for example, when receiving an information recording instruction, information to be recorded, and an address in which the information is to be recorded, from an external device and the like (not illustrated) in a state where the hologram disc 100 is loaded, the control section 61 supplies a drive instruction to the drive control section 62, according to an information recording program and the like. The drive control section 62 controls the drive of the spindle motor 64 according to the drive instruction, thereby rotating the hologram disc 100 at a constant linear velocity, for example. In addition, the drive control section 62 controls the drive of the sled motor 65 according to the drive instruction, thereby moving the optical pickup 66 along the moving axis 65A. The signal processing section 63 performs predetermined coding, modulation processing, and the like on information to be recorded, thereby generating a recording signal represented by symbols of the values “0” and “1”, for example. The drive control section 62 generates a laser drive signal based on the recording signal supplied from the signal processing section 63, and then supplies the laser drive signal to the optical pickup 66. The optical pickup 66 irradiates one surface of the hologram disc 100 with an optical beam based on the recording signal while performing the focus control and the tracking control which are described later, thereby forming mark trains based on the recording signal to record information.

At the time of reproduction, for example, when receiving an information reproducing instruction and an address to be reproduced from an external device and the like (not illustrated) in a state where the hologram disc 100 is loaded, the control section 61 supplies an drive instruction to the drive control section 62 according to the information reproducing program and the like. The drive control section 62 controls the drive of the spindle motor 64 according to the drive instruction, thereby rotating the hologram disc 100 at a constant linear velocity, for example. In addition, the drive control section 62 controls the drive of the sled motor 65 according to the drive instruction, thereby moving the optical pickup 66 along the moving axis 65A. Moreover, the drive control section 62 irradiates one surface of the hologram disc 100 with a light beam while performing the focus control and the tracking control of the optical pickup 66. The detected reflected-light information is supplied to the signal processing section 63, and then is subjected to binary processing, decoding, error correcting processing, and the like. Therefore, data recorded in the hologram disc 100 is reproduced.

In such a way, the recording/reproducing device 60 records information into the initialized hologram disc 100, and reproduces information from the hologram disc 100 in which the information is recorded, while performing the position control such as the focus control and the tracking control.

A configuration of the optical pickup 66 will be described. As schematically illustrated in FIG. 5, the optical pickup 66 irradiates one surface of the hologram disc 100 with a light beam (recording/reproducing light).

Incidentally, the hologram disc 100 includes the recording layer 103 having interference patterns uniformly formed by the above-described initialization processing. In addition, in this case, the configuration of the hologram disc 100 in which a reference surface 102 for obtaining a reference of the servo control is formed is exemplified. The reference surface 102 serves as a focal servo reference surface, and has a spiral groove or concentric grooves (or pit trains) as a tracking guide.

The optical pickup 66 is configured of two major optical systems, namely, a servo optical system 70 and a recording/reproducing optical system 80. The servo optical system 70 irradiates the hologram disc 100 with servo light L1, and receives reflected servo light L2 which is obtained by reflection of the servo light L1 by the hologram disc 100.

A servo laser 21 of the servo optical system 70 is configured of, for example, a semiconductor laser. The servo laser 21 emits a predetermined amount of servo light L1 including divergent light, based on the control of the control section 61 in FIG. 4. The servo light L1 is converted from the divergent light into parallelized light by a collimator lens 22, and the parallelized light enters a beam splitter 23. The beam splitter 23 has wavelength selectivity (dichroic properties) with reflectance different depending on wavelength of the light beam, and reflects, for example, servo light with wavelength λs at approximately 100%. Incidentally, it is assumed that when recording/reproducing light L11 outputted from a recording/reproducing laser 81 which will be described later has a wavelength λr, the beam splitter 23 allows light with the wavelength λr to transmit therethrough at approximately 100%. The wavelength λs of the servo light L1 is longer than the wavelength λr of the recording/reproducing light L11. As an example, the wavelength λs of the servo light L1 is 650 nm, and the wavelength λr of the recording/reproducing light L11 is 405 nm.

The servo light L1 having reflected by the beam splitter 23 enters a subsequent beam splitter 24. The beam splitter 24 allows the servo light L1 to transmit therethrough at approximately 50% and reflects the remaining light component. The servo light L1 having transmitted through the beam splitter 24 is collected by an objective lens 25, and is applied onto one surface of the hologram disc 100. At this time, the servo light L1 is focused on the reference surface 102 of the hologram disc 100, and is reflected by the reference surface 102. The reflected servo light L2 reflected by the reference surface 102 becomes divergent light as the servo light L1 is convergent light, and is converted into parallelized light by the objective lens 25 to enter the beam splitter 24. The parallelized light is reflected by the beam splitter 24 at approximately 50%, and then enters a condenser lens 26. The condenser lens 26 focuses the reflected servo light L2 to apply the light to a photodetector 27. The photodetector 27 has detection regions necessary for obtaining, for example, a focus error signal in an astigmatism method and a tracking error signal in a push-pull method, and supplies photoelectric conversion signals for these detection regions to a servo control circuit 29.

The servo control circuit 29 generates a focus error signal and a tracking error signal with use of the photoelectric conversion signal from the photodetector 27 to supply, based on these signals, an actuator 28 with a focus servo drive signal and a tracking servo drive signal.

The actuator 28 is provided between an optical pickup 66 and a lens holder (not illustrated) for holding the objective lens 25, and drives the objective lens 25 to move in a focus direction based on the focus drive signal. In addition, the actuator 28 drives the objective lens 25 to move in a tracking direction based on the tracking drive signal. Accordingly, the objective lens 25 is subjected to feedback control so that the servo light L1 is focused on a groove (a reference target track) on the reference surface 102 of the hologram disc 100.

Incidentally, when the groove on the reference surface 102 is wobbled based on address information, or when the address information is recorded as a pit train or the like, the servo control circuit 29 is allowed to extract the address information from detected information of the reflected servo light L2 to supply the address information to the control section 61 and the like in FIG. 4. For example, at the time of recording, recording operation may be controlled to be executed with use of the address information. Note that, at the time of reproduction, in addition to the address information from the reference surface 102, address information read together with recorded data from the mark train formed in the recording layer 103 may be used for control.

The recording/reproducing optical system 80 irradiates one surface of the hologram disc 100 with the recording/reproducing light L11 and detects reflected recording/reproducing light L12. The recording/reproducing laser 81 of the recording/reproducing optical system 80 is configured of, for example, a semiconductor laser, and emits laser light with a wavelength λr. In a case where information is recorded into the hologram disc 100, based on the control of the control section 61 (FIG. 4), the recording/reproducing laser 81 emits the recording/reproducing light L11 including divergent light at relatively high intensity, and allows the recording/reproducing light L11 to enter a collimator lens 82.

The collimator lens 82 converts the recording/reproducing light L11 from divergent light into parallelized light, and allows the recording/reproducing light L11 thus parallelized to enter a beam splitter 83. The beam splitter 83 allows the recording/reproducing light L11 to transmit therethrough at a predetermined ratio and then enter a relay lens 84. The relay lens 84 converts the recording/reproducing light L11 from the parallelized light into convergent light or divergent light with use of a movable lens 84A, further changes convergent state of the recording/reproducing light L11 with use of a fixed lens 84B, and allows the recording/reproducing light L11 to enter the beam splitter 23.

As described above, the beam splitter 23 allows the recording/reproducing light L11 with the wavelength λr to transmit therethrough and enter the beam splitter 24. The beam splitter 24 allows the recording/reproducing light L11 to transmit therethrough at a predetermined ratio and enter the objective lens 25. The objective lens 25 collects the recording/reproducing light L11 to be applied onto the hologram disc 100.

The focal position of the recording/reproducing light L11 is determined based on the convergent state at the time of emitting the recording/reproducing light L11 from the fixed lens 84B of the relay lens 84. In other words, the focal point of the recording/reproducing light L11 is located on a certain depth position in the recording layer 103 according to the position of the movable lens 84A under control of the control section 61. In other words, in a state where the objective lens 25 is subjected to focus control so that the servo light L1 is focused on the reference surface 102, the recording/reproducing light L11 is focused on a position in a depth direction of the hologram disc 100 by a predetermined offset amount, compared with the servo light L11. Therefore, the movable lens 84A controls the recording/reproducing light L11 to be focused on arbitrary depth position in the recording layer 103.

At the time of recording, mark recording is performed by focusing the recording/reproducing light L11 on a certain depth position in the recording layer 103. In other words, optical energy, thermal energy, and the like of the recording/reproducing light L11 are converged on the focal position so that interference patterns near the focal position are destroyed or changed thermally or photochemically, and recording marks locally lacking a hologram property are formed. Consequently, the recording/reproducing device 60 outputs the recording/reproducing light L11 which has been modulated based on the recording signal obtained by subjecting information-to-be-recorded to a predetermined modulation processing and the like by the signal processing section 63 so that a mark train based on the recording signal may be formed. Note that at the time of recording in which a mark train has not yet formed, the tracking control by the above-described reflected servo light L2 is performed. Therefore, the mark train formed on a certain depth position in the recording layer 103 has a planar spiral shape or a planar concentric shape along the spiral groove or the concentric grooves (or the pit trains) formed on the reference surface 102.

Moreover, as described above, the focal position of the recording/reproducing light L11 is allowed to be controlled by the movable lens 84A. Therefore, by changing the depth position as the focal position, mark trains are formed in different depth positions in the recording layer 103. In other words, multilayer mark recording is achievable. FIG. 5 schematically illustrates a state of the recording layer 103 where after a mark train is formed near the reference surface 102, another mark train as a second layer is being recorded.

On the other hand, at the time of reproducing information from the hologram disc 100, the control section 61 allows the recording/reproducing laser 81 to emit the recording/reproducing light L11 at a relatively low intensity. Moreover, the movable lens 84A controls the focal position of the recording/reproducing light L11 to a depth position corresponding to a layer of a predetermined mark train to be reproduced. Therefore, the recording/reproducing light L11 is applied to a portion provided with the mark train to be reproduced. At this time, reflected light from the mark train is the reflected recording/reproducing light L12 having reflected light component according to the presence or absence of the marks.

The reflected recording/reproducing light L12 travels in the light path of the recording/reproducing light L11 in an opposite direction. In other words, the reflected recording/reproducing light L12 is transmitted through the objective lens 25, the beam splitter 24, the beam splitter 23, and the relay lens 84 in this order, and then enters the beam splitter 83. The beam splitter 83 allows a part of the reflected recording/reproducing light L12 to enter the condenser lens 86 by reflecting the part of the light L12. The reflected recording/reproducing light L12 is converged and then applied to the photodetector 87 by the condenser lens 86.

The photodetector 87 generates an electrical signal (a reproducing signal) according to detected light amount obtained by receiving the reflected recording/reproducing light L12. Then, the photodetector 87 transmits the generated electrical signal to the signal processing section 63. The signal processing section 63 performs binarization, decoding, error correction, and the like on the reproducing signal from the photodetector 87 to reproduce information recorded in the hologram disc 100, and then supplies the information to the control section 61. The control section 61 accordingly transmits the reproduced information to an external device.

In this way, the recording/reproducing device 60 destroys (changes) or maintains an initial hologram according to information to be recorded, at the time of recording the information into the hologram disc 100. In addition, at the time of reproducing information from the hologram disc 100, the recording/reproducing device 60 detects reflected light (reflected recording/reproducing light L12) from the mark train of the recording/reproducing light L11, and reproduces the information based on the detected result. Note that although the description is given herein for the recording/reproducing device 60, a reproduction-only device without recording function may be realized with substantially the same configuration.

### (3. Relationship Between Initializing Wavelength, Pitch of Interference Patterns, and Reproducing Wavelength)

As described above, in the case of the embodiment, first, initialization for forming interference patterns uniformly in the hologram disc 100 is performed. In the initialized hologram disc 100, recording laser light (recording/reproducing light L11 with high power) modulated based on the recording information is corrected into the recording layer 103 to form mark trains having marks with the interference patterns erased or changed. In the hologram disc 100 in which information is recorded, reflected light of the reproducing light (recording/reproducing light L11 with low power) from the mark train is detected to obtain its reproducing signal, and thus reproducing information is obtained. A relationship between an initializing wavelength, a pitch of the interference patterns, and a reproducing wavelength for obtaining a suitable reproducing signal in this case will be described below.

As described above, the initialization device 10 performs initialization with use of initializing light with wavelength λf. On the other hand, the recording/reproducing device 60 performs reproduction with use of reproducing light with wavelength λr. In this case, reproducing signal characteristics were examined by varying the relationship (λf/λr) of wavelength λf of the initializing light to wavelength λr of the reproducing light.

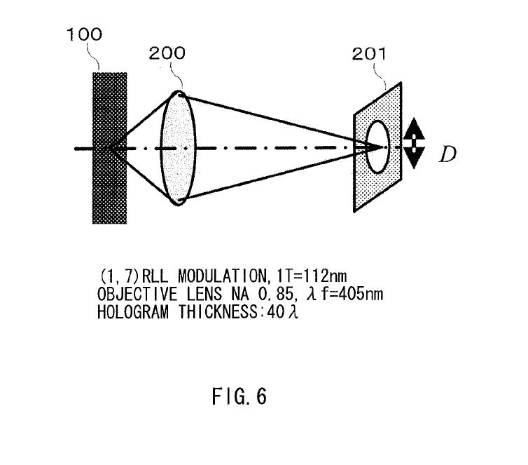

As schematically illustrated in FIG. 6, detections at the time of the examination was performed after light is passed through a pinhole 201, and the size (diameter D) of the pinhole 201 was calculated for two types with respect to NA of collection system 200, that is, diameters λ/NA and 4*λ/NA. The collection system 200 indicates an optical system of the reflected recording/reproducing light L12 in the recording/reproducing device 60, and for example, as illustrated in FIG. 5, the photodetector 87 in the collection system 200 performs detection of light after light is passed through the pinhole 201. In addition, it was assumed that mark trains with 1T=112 nm were formed in the hologram disc 100, based on a recording signal by Run Length Limited (RLL) (1-7) modulation. The thickness of the recording layer in the hologram disc 100 was set to 40λ. NA of the objective lens 25 was set to 0.85, and the wavelength λr of the reproducing light was set to 405 nm.

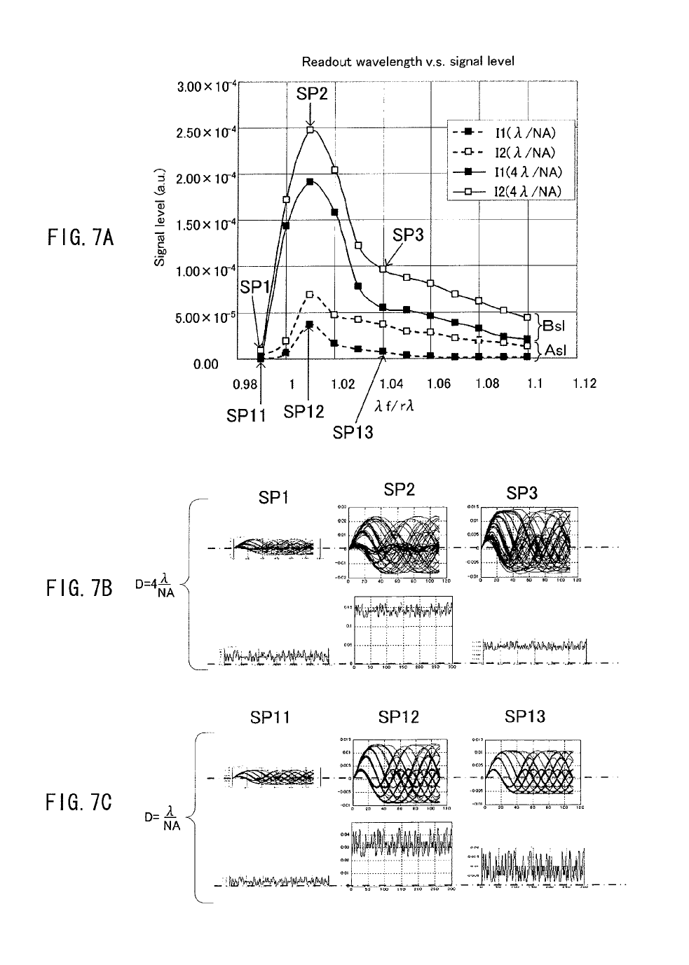

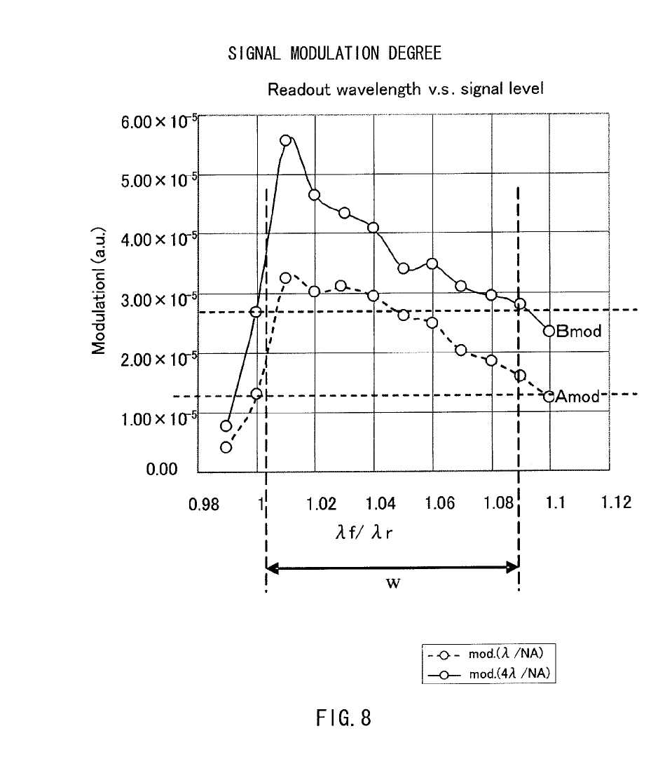

FIG. 7A illustrates level characteristics of the reproducing signal with respect to (λf/λr), and FIG. 8 illustrates characteristics of modulation degree of the reproducing signal with respect to (λf/λr). Note that as a calculation method of reproducing signal, an example described in “Analysis of Micro-Reflector 3-D optical disc recording”, Kimihiro Saito and Seiji Kobayashi, Proceedings of SPIE, Vol. 6282, 628213 (2007) is cited.

In FIG. 7A, the reproducing signal level was determined by varying the value of (λf/λr) in a range of 0.99 to 1.1. For example, in a case where the wavelength λr of the reproducing light was fixed to 405 nm, varying the value of (λf/λr) in the range of 0.99 to 1.1 means that the wavelength λf of the initializing light was varied in a range of 400.95 nm to 445.5 nm. In other words, the characteristics illustrated herein are reproducing signal characteristics in a case where data is recorded into multiple hologram discs 100 which are initialized by initializing light with respective wavelengths λf, and the data is reproduced with use of reproducing light with the wavelength λr of 405 nm.

As described with reference to FIG. 1 and FIGS. 2A and 2B, in the case where the plane wave is perpendicularly applied to the both surfaces of the hologram disc 100, the pitch of the interference patterns formed is λf/2N (N is a refractive index of a material of the recording layer 103). Therefore, the characteristics of the reproducing signal level obtained by varying the value of (λf/λr) in the range of 0.99 to 1.1 is considered as the characteristics in a case where pitches of the interference patterns are different from one another.

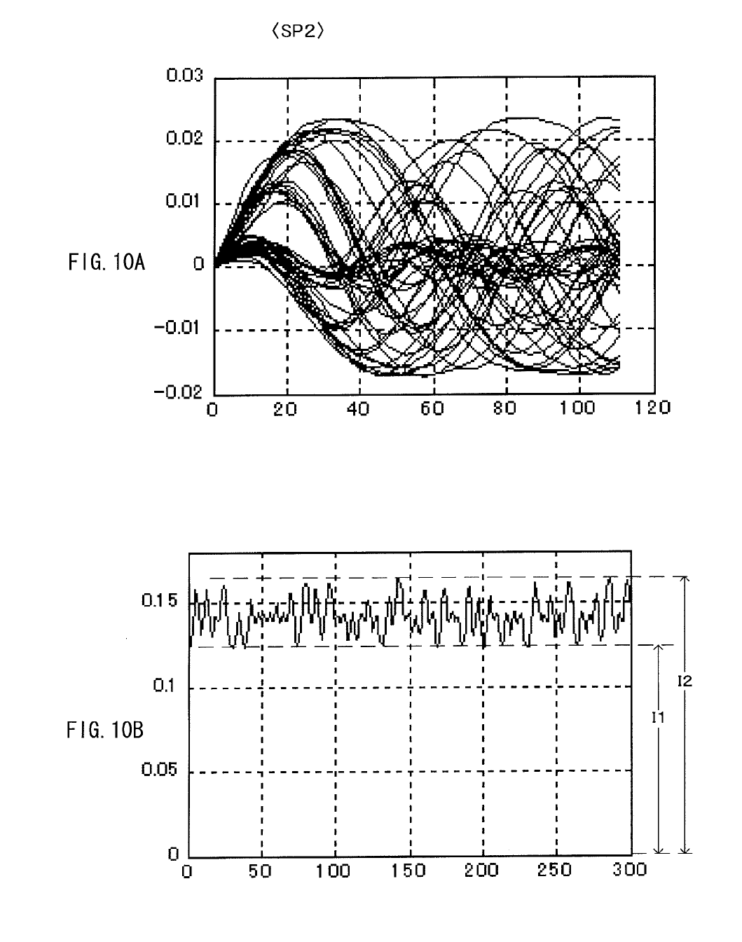

The characteristics As1 illustrated by dashed lines in FIG. 7A indicate a bottom level I1 and a peak level I2 of the reproducing signal in the case where the above-described pinhole diameter D is λr/NA. The characteristics Bs1 illustrated by solid lines in FIG. 7A indicate the bottom level I1 and the peak level I2 of the reproducing signal in the case where the above-described pinhole diameter D is λr/NA. The bottom level I1 and the peak level I2 are values of the bottom level and the peak level in the reproducing signal waveform as illustrated in FIGS. 10A and 10B, for example. Since DC component is added to the reproducing signal, it is considered that the bottom level I1 is approximately equivalent to the level of the DC component, and modulation degree is obtained by subtracting the bottom level I1 from the peak level I2 (I2−I1).

Characteristics Amod and Bmod in FIG. 8 indicate the modulation degree of the reproducing signal corresponding to the characteristics As1 and Bs1 of FIGS. 7A to 7C, respectively. In FIG. 8, the vertical axis indicates the modulation degree (I2−I1), and the horizontal axis indicates (λf/λr) as in FIG. 7A.

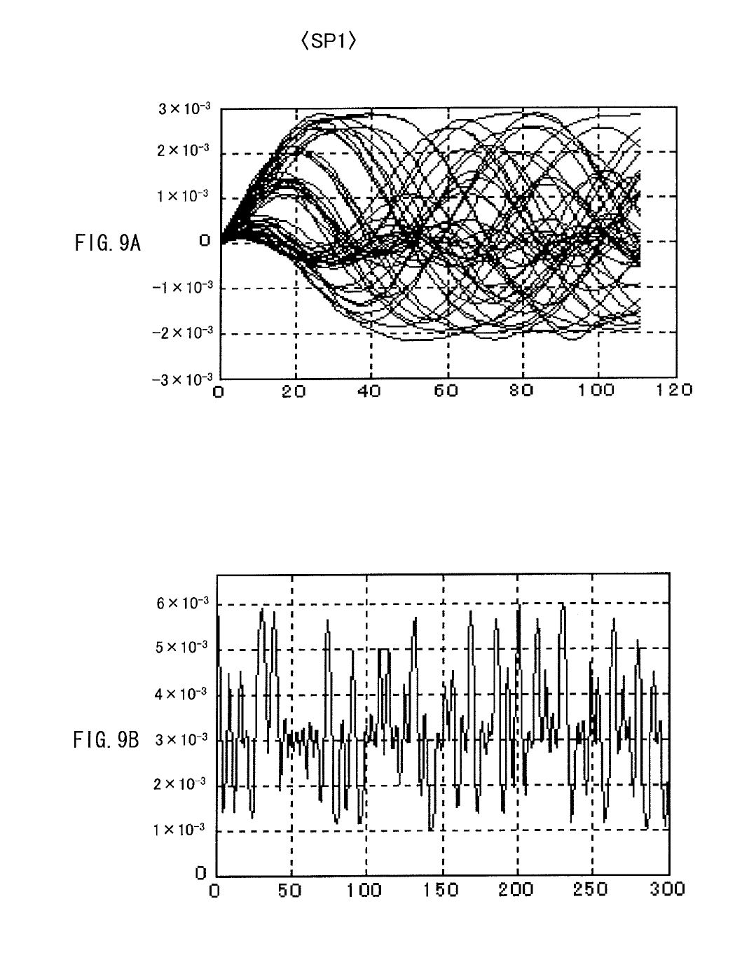

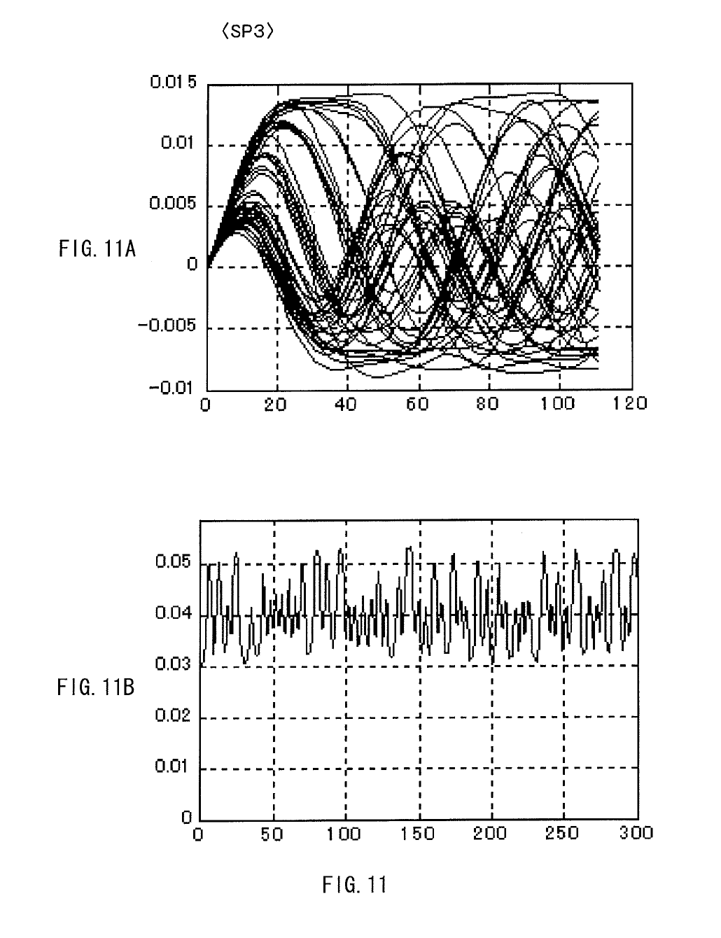

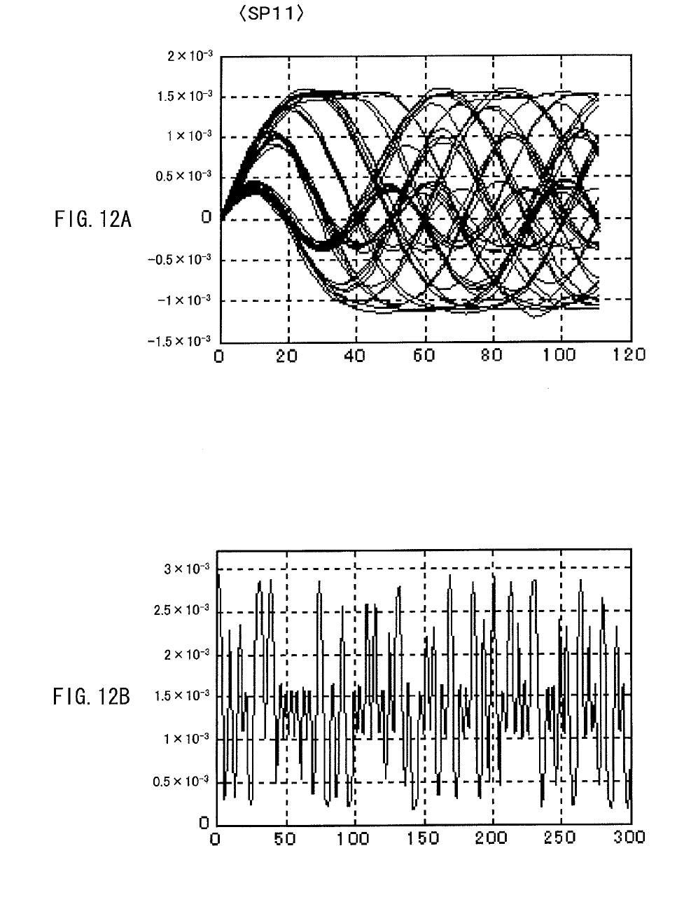

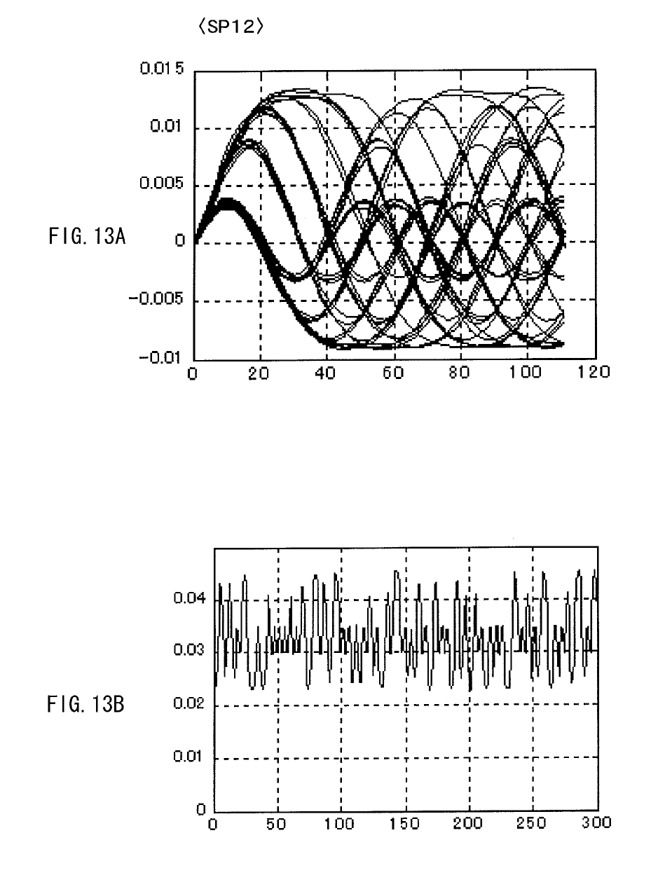

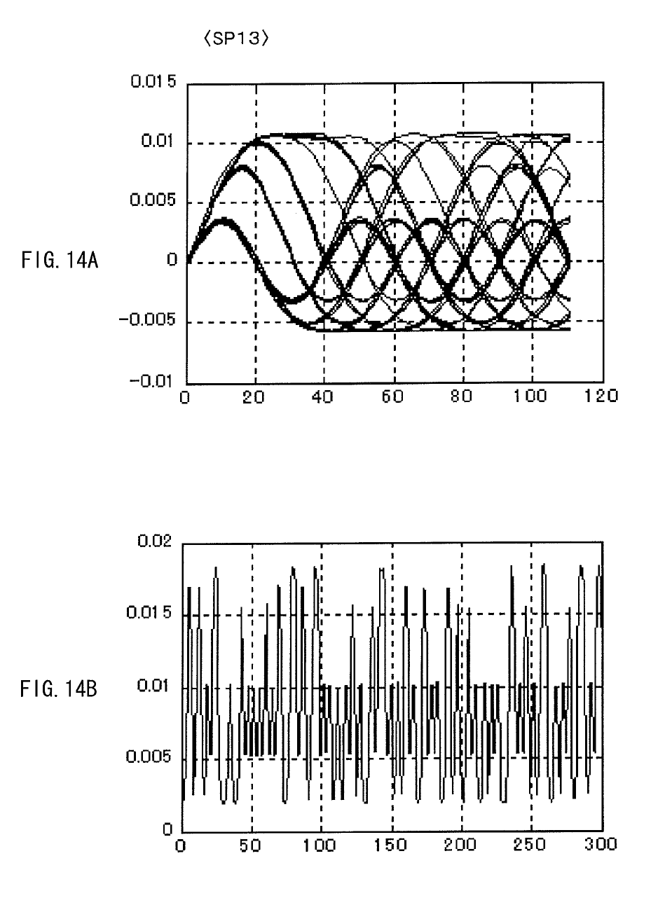

FIGS. 9A and 9B, FIGS. 10A and 10B, and FIGS. 11A and 11B illustrate respective eye patterns of the reproducing signals (FIGS. 9A, 10A, and 11A) and respective reproducing signal waveforms (FIGS. 9B, 10B, and 11B) at sample points SP1, SP2, and SP3 in the measurement of the characteristics Bs1 of FIG. 7A. The sample point SP1 is a case where λf/λr is 0.99, the sample point SP2 is a case where λf/λr is 1.01, and the sample point SP3 is a case where λf/λr is 1.04. FIG. 7B illustrates the eye pattern and the reproducing signal waveform at each of the sample points SP1, SP2, and SP3 which are scaled down and plotted in the same scale while the vertical axes are aligned for comparison. Moreover, FIGS. 12, 13, and 14 illustrate respective eye patterns of the reproducing signals and respective reproduction signal waveforms at the sample points SP11, SP12, and SP13 in the measurement of the characteristics As1 in FIG. 7A. The sample point SP11 is a case where λf/λr is 0.99, the sample point SP12 is a case where λf/λr is 1.01, and the sample point SP13 is a case where λf/λr is 1.04. FIG. 7C illustrates the eye pattern and reproducing signal waveform at each of the sample points SP11, SP12, and SP13 which are scaled down and plotted in the same scale while the vertical axes are aligned, for comparison.

From measurement results of the reproducing signal level and the modulation degree illustrated in FIG. 7A and FIG. 8, the following is understood. First, the case where λf/λr is 1 indicates the case where the wavelength λf of the initializing light is equal to the wavelength λr of the reproducing light. Considering the case as a reference, it is apparent from FIG. 8 that the modulation degree is increased in a case where the wavelength λf of the initializing light is longer than the wavelength λr of the reproducing light. Specifically, as for the modulation degree, although when the value of λf/λr is around 1.01 or 1.02, sufficient modulation degree is obtainable and is suitable as a reproducing signal, in a range represented by W in FIG. 8, specifically, when the value of λf/λr is in a range of 1.005 to 1.09, the modulation degree is equal to or larger than that in the case of λf/λr being 1 and is suitable as a reproducing signal.

In addition, compared with a case where the λf/λr is lower than 1 like the sample points SP1 and SP11, at the sample points SP2, SP3, SP12, and SP13 in which λf/λr is larger than 1, an amplitude of the reproducing signal is increased and the eye pattern relatively looks good (refer to FIGS. 7B and 7C and FIGS. 9A and 9B to FIGS. 14A and 14B). From this point, it is understood that a suitable reproducing signal is obtained in the case where the wavelength λf of the initializing light is longer than the wavelength λr of the reproducing light.

Note that although at the sample points SP2, SP 12, and the like, the reproducing signal level is highest when the value of λf/λr is around 1.01 or 1.02, since the reproducing signal level itself is largely affected by DC component, higher level may not be suitable directly. The higher modulation degree as described above is important as a reproducing signal.

With all these factors, the following is directed. First, in a case where the wavelength λr of the reproducing light is fixed to a certain wavelength (for example, 405 nm), to initialize the hologram disc 100 with use of a plane wave with the wavelength λf it is preferable that the interference patterns be formed with a pitch wider than λr/2N. Therefore, setting the wavelength λf of the initializing light to be larger than λr allows the pitch of the interference patterns formed to be wider than λr/2N. For example, the laser light source 1 of the initializing device 10 in FIG. 1 emits initializing light with the wavelength λf larger than a Specifically, from the viewpoint of the modulation degree, the wavelength λr of the initializing light is preferably selected so that the value of λf/λr is in a range of 1.005 to 1.09. In the case where the wavelength λr of the reproducing light is set to 405 nm as an example, the wavelength λf of the initializing light from the laser light source 1 of the initializing device 10 is preferably selected in a range of 407.025 nm to 441.45 nm.

In terms of the hologram disc 100, it is preferable that the interference patterns formed in the recording layer 103 have a pitch wider than λr/2N with respect to the wavelength λr of the reproducing light. Specifically, considering that the value of λf/λr is in a range of 1.005 to 1.09 from the viewpoint of the modulation degree, the pitch of the interference patterns of the hologram disc 100 is preferably in a range of (λr*1.005)/2N to (λr*1.09)/2N.

Considering the reproducing method in the recording/reproducing device 60, when the pitch of the interference patterns of the hologram disc 100 is represented by λf/2N with use of the wavelength λf of the initializing light, it is suitable that the reproducing light with wavelength λr smaller than λf is applied to the above-described recording layer, and information is reproduced from its reflected light. Specifically, it is suitable that the reproducing light with the wavelength λr, which allows the value of λf/λr to be in a range of 1.005 to 1.09, is applied, and information is reproduced from its reflected light. As an example, considering a case where the initializing light with the wavelength λf of 405 nm is used for initialization in the initializing device 10, to allow the value of λf/λr to be in a range of 1.005 to 1.09, the recording/reproducing device 60 may set the wavelength λr of the recording/reproducing light L11 (wavelength of a reproducing light) outputted from the recording/reproducing laser 81 in a range of 402.985 to 371.56.

As described above, a reproducing signal with favorable eye-pattern quality is obtainable from the relationship of λf>λr, and further when λf/λr is set in a range of 1.005 to 1.09, a reproducing signal with sufficient modulation degree is obtainable. To do that, when the initialization is performed with use of parallelized light as described above, initializing light having a wavelength λf longer than a wavelength λr of reproducing light is preferably used. Alternatively, in contrast, a wavelength λr of reproducing light may be shorter than a wavelength λf of initializing light.

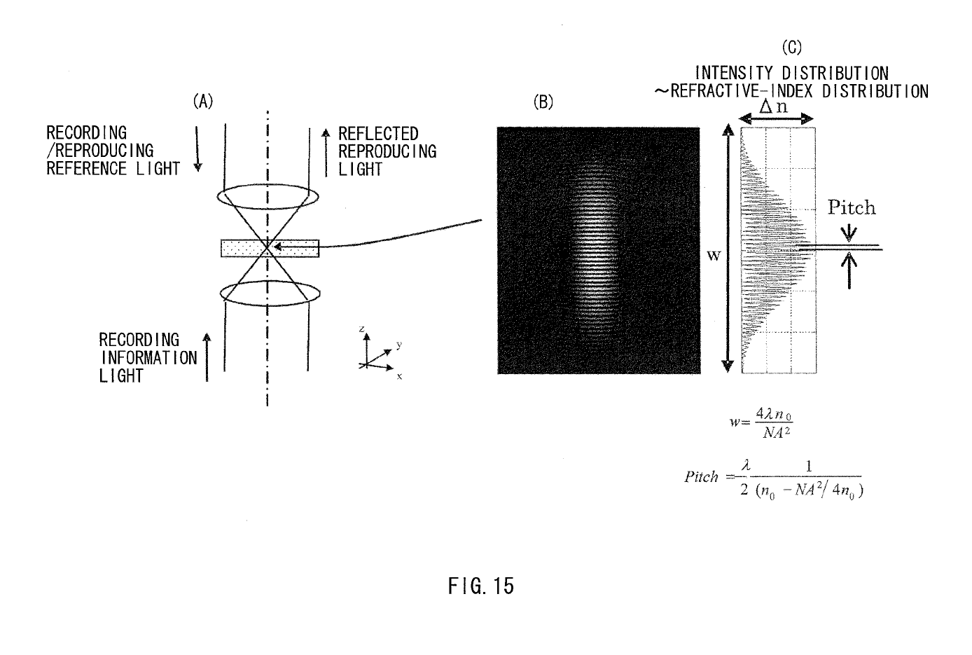

Incidentally, a pitch (on an optical axis) of micro-holograms formed by a light collection optical system is λ/2N*(1−(NA²/4N²)). Parts (A) and (B) of FIG. 15 illustrate micro-holograms formed by collecting recording/reproducing reference light and recording information light from both sides and irradiating a recording medium with the collected light. Part (C) of FIG. 15 illustrates a refractive-index distribution of the micro-holograms. The pitch in the case where micro-holograms are formed by a light collection optical system in this way is wider than a pitch (λ/2N) in the case where interference patterns are formed with use of the parallelized light as the above-described example.

The description is given on this point. It is considered a case where an average refractive index in a recording medium is N, and recording light (recording/reproducing reference light u(r, z) and recording information light v(r, z)) is collected from the front and back surfaces of the recording medium through a uniform opening NA. The recording/reproducing reference light u and the recording information light v are represented as follows (plane wave expansion, vertical direction is a symbol of z).

$$[ Numerical Expression 1 ]$$

$$u ( r , z ) = {\int }_{p \leq NA} u ( p ) exp ( {ik}_{0} ( p \cdot r + z \sqrt{{N}^{2} - {p}^{2}} ) ) d p$$

$$v ( r , z ) = {\int }_{p \leq NA} v ( p ) exp ( {ik}_{0} ( p \cdot r - z \sqrt{{N}^{2} - {p}^{2}} ) ) d p$$

where r=(x, y) indicates a coordinate in the recording medium, p=(pₓ, p_{y}) indicates a coordinate on an objective lens (opening: |p|≦NA), k₀=2π/λ, and λ is a vacuum wavelength.

For considering only a pitch, r=(x, y)=(0, 0) is assumed and a distribution on z-axis (on an optical axis) is considered.

$$[ Numerical Expression 2 ]$$

$$u ( 0 , z ) = {\int }_{p \leq NA} u ( p ) exp ( {ik}_{0} z \sqrt{{N}^{2} - {p}^{2}} ) d p$$

$$v ( 0 , z ) = {\int }_{p \leq NA} v ( p ) exp ( - {ik}_{0} z \sqrt{{N}^{2} - {p}^{2}} ) d p$$

Herein, the following expression is assumed:

$$[ Numerical Expression 3 ]$$

$$\sqrt{{N}^{2} - {p}^{2}} \approx N ( 1 - \frac{{p}^{2}}{2 {N}^{2}} )$$

and integration for p is performed.

$$[ Numerical Expression 4 ]$$

$$u ( 0 , z ) = π {NA}^{2} exp ( {ik}_{0} z ( N - \frac{{NA}^{2}}{4 N} ) ) Sinc ( \frac{{k}_{0} {zNA}^{2}}{4 N} )$$

$$v ( 0 , z ) = π {NA}^{2} exp ( - {ik}_{0} z ( N - \frac{{NA}^{2}}{4 N} ) ) Sinc ( \frac{{k}_{0} {zNA}^{2}}{4 N} )$$

The intensity distribution |u(0, z)+v(0, z)|² is expressed as:

$$[ Numerical Expression 5 ]$$

$${( 2 π {NA}^{2} )}^{2} cos ( {k}_{0} zN ( 1 - \frac{{NA}^{2}}{4 {N}^{2}} ) ) {Sinc}^{2} ( \frac{{k}_{0} {zNA}^{2}}{4 N} )$$

In the expression, (1−NA²/4N²) is added to k₀zN so that the pitch of the micro-holograms becomes λ/2N*(1−(NA²/4N²)). In other words, the pitch of the micro-holograms is wider than λ/2N.

For this reason, as the case of the embodiment, even in a case where initialization is performed with use of a plane wave so as to form interference patterns parallel to a surface of the hologram disc 100, by setting the relationship between the wavelength λf of the initializing light and the wavelength λr of the reproducing light as described above, a reproducing signal at a similar level to that in the case of forming micro-holograms by a collection system is obtainable. In other words, also in a method of the embodiment in which interference patterns are uniformly formed in initialization, a reproducing signal with quality similar to that in the recording method of forming micro-holograms with use of a collection system is obtainable. Specifically, it is also suitable that a pitch of the interference patterns of the hologram disc 100 is set to λ/2N*(1−(NA²/4N²)) by setting the wavelength λf of the initializing light.

### (4. Example of Another Initializing Device)

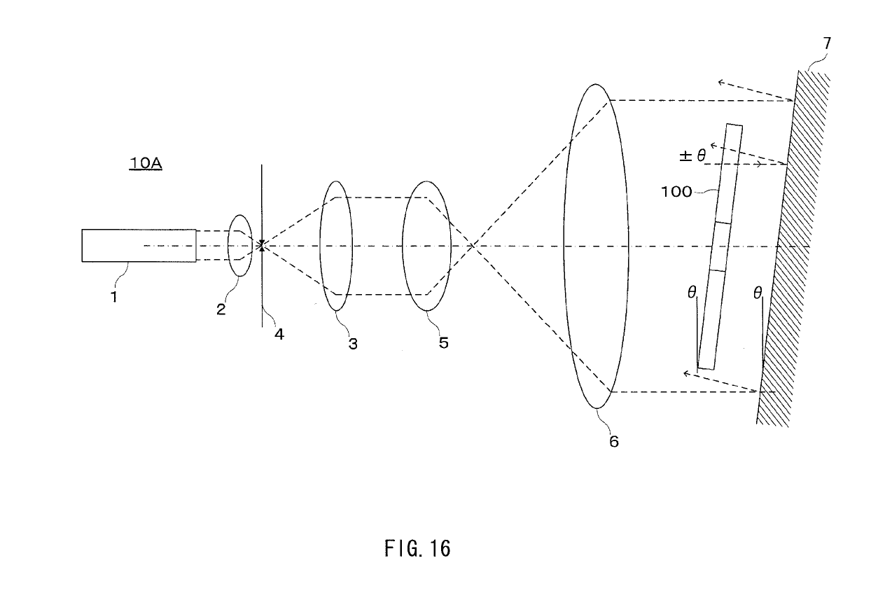

A configuration example of another initializing device 10A as an embodiment will be described with reference to FIG. 16. The laser light source 1 outputs initializing light having a wavelength λf. The configurations of the lenses 2 and 3, the spatial filter 4, and the lenses 5 and 6 are similar to those in FIG. 1. In this case, with respect to the lens 6 obtaining initializing light of a plane wave, the hologram disc 100 is disposed obliquely by an angle θ. In addition, the mirror 7 is also disposed obliquely to the lens 6 by the angle θ. Therefore, parallelized light of a plane wave obtained from the lens 6 is uniformly applied to one surface of the hologram disc 100 at an incident angle +θ to an optical axis. Moreover, the initializing light of a plane wave is reflected by the mirror 7 after passing through the hologram disc 100. Therefore, the plane wave is also applied to another surface (an opposite surface) of the hologram disc 100 at a time at an incident angle −θ to the optical axis.

In other words, with respect to the recording layer 103 of the hologram disc 100, the incident angle of the initializing light applied to one surface is different from the incident angle of the initializing light applied to another surface. In other words, the initializing device 10A has a first irradiation optical system irradiating one surface of the recording layer of the hologram disc 100 with the initializing light of a plane wave with the wavelength λf at a first incident angle +θ, and a second irradiation optical system irradiating another surface thereof with the initializing light at a second incident angle −θ. Note that the configuration of the initializing device 10A is merely an example, and another configuration is also available. For example, the first and second incident angles may be different from each other after the second irradiation optical system is formed with a light path independent of the first irradiation optical system.

In a case where the initializing light enters from a front surface and a back surface at different incident angles in this way, the pitch of interference patterns formed is wide. In this case, the pitch of the interference patterns is wider than λf/2N by 1/cos θ. In other words, setting of the incident angles of the initializing light from the front and back surfaces also controls the pitch of the interference patterns of the hologram disc 100. Then, to form an appropriate pitch of the interference patterns to the wavelength λr of the reproducing light, it is not necessary that the wavelength λf of the initializing light is larger than the wavelength λr of the reproducing light. For example, when λf=λr is established, in a case where the interference patterns are formed by irradiating one surface and another surface of the hologram disc 100 with the initializing light of a plane wave with wavelength λf, the interference patterns may be formed with a pitch wider than λr/2N. In this way, at the time of reproduction with use of the wavelength λr (=λf) of the reproducing light, a suitable reproducing signal is obtainable. Accordingly, even if the wavelength λf of the initializing light needs to be equal to the wavelength λr of the reproducing light, a system capable of providing a reproducing signal with high quality is achievable. Obviously, also in a case of λf>λr being established, such an initializing device 10A may be used.

Note that although initialization is preformed in the initializing device 10 or 10A in FIG. 1 or FIG. 16 according to the embodiment, depending on a material of the hologram recording medium, volume contraction may occur after the initialization. In such a case, the pitch of the interference patterns may be narrowed. In a case where the hologram disc 100 made of a material causing such a volume contraction is used, degree of narrowing of the interference patterns due to the volume contraction is foreseen in advance, and according to the degree, the wavelength λf of the initializing light or the wavelength λr of the reproducing light may be adjusted and set.

The present application contains subject matter related to that disclosed in Japanese Priority Patent Application JP 2010-260987 filed in the Japan Patent Office on Nov. 24, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A method of initializing a recording medium having a first surface and a second surface which face to each other with a recording layer in between, the method comprising
forming interference patterns to have a pitch wider than λr/2N by applying initializing light of a plane wave with a wavelength λf to the recording layer from both of the first surface side and the second surface side, where λr is a wavelength of reproducing light applied to the recording layer at the time of reproducing recorded information, and N is an average refractive index of the recording layer.

2. The method according to claim 1, wherein a pitch of the interference patterns formed is wider than λr/2N by setting the wavelength λf of the initializing light to be larger than λr.

3. The method according to claim 2, wherein a value of λf/λr is in a range of 1.005 to 1.09.

4. The method according to claim 1, wherein a pitch of the interference patterns formed is wider than λr/2N by setting the wavelength λf of the initializing light to be equal to or larger than λr, and setting an incident angle of the initializing light applied from the first surface on the recording layer to be different from an incident angle of the initializing light applied from the second surface on the recording layer.

5. An initializing device comprising:
a first irradiation optical system applying initializing light of a plane wave with a wavelength λf to a recording layer of a recording medium, which has a first surface and a second surface which face to each other with the recording layer in between, from the first surface side; and
a second irradiation optical system applying initializing light of a plane wave with a wavelength λf to the recording layer from the second surface side,
where when the wavelength of reproducing light applied to the recording layer at the time of reproducing recorded information is λr, the wavelength λf of the initializing light is larger than λr, and a value of λf/λr is within a range of 1.005 to 1.09.

6. An initializing device comprising:
a first irradiation optical system applying initializing light of a plane wave with a wavelength λf to a recording layer of a recording medium, which has a first surface and a second surface which face to each other with the recording layer in between, from the first surface at a first incident angle; and
a second irradiation optical system applying initializing light of a plane wave with a wavelength λf to the recording layer from the second surface side at a second incident angle different from the first incident angle,
where when the wavelength of reproducing light applied to the recording layer at the time of reproducing recorded information is λr, the wavelength λf of the initializing light is equal to or larger than λr.

7. A recording medium comprising a recording layer, wherein
a pitch of interference patterns in the recording layer is wider than λr/2N,
where λr is a wavelength of reproducing light applied to the recording layer at the time of reproducing recorded information and N is an average refractive index of the recording layer.

8. The recording medium according to claim 7, wherein the pitch of the interference patterns is in a range of (λr*1.005)/2N to (λr*1.09)/2N.

9. A method of reproducing information comprising
applying reproducing light having a wavelength λr smaller than λf to a recording layer of a recording medium and reproducing information from reflected light of the reproducing light, the recording layer including interference patterns formed at a pitch of λf/2N,
where λf is a wavelength of initializing light of a plane wave in a case where interference patterns having a pitch of λf/2N is formed by applying the initializing light to the recording layer from both of facing two surface sides of the recording medium at the time of forming the interference patterns on the recording layer for initializing the recording medium, and N is an average refractive index of the recording layer.

10. The reproducing method according to claim 9, wherein the recording layer is irradiated with the reproducing light with the wavelength λr allowing a value of λf/λr to be in a range of 1.005 to 1.09, and information is reproduced from reflected light of the reproducing light.
